(19) United States
(12) Patent Application Publication
(10) Pub. No.: US 2025/0014789 A1
(43) Pub. Date: Jan. 9, 2025

(54) CHIP-TYPE ELECTRONIC COMPONENT

(71) Applicant: Murata Manufacturing Co., Ltd., Nagaokakyo-shi (JP)

(72) Inventors: Masakiyo NAGATOMO, Nagaokakyo-shi (JP); Keisuke ISOGAI, Nagaokakyo-shi (JP); Naoaki ABE, Nagaokakyo-shi (JP); Hikaru UEGAKI, Nagaokakyo-shi (JP); Yoshinobu SAKI, Nagaokakyo-shi, Kyoto-fu (JP)

(21) Appl. No.: 18/896,240

(22) Filed: Sep. 25, 2024

Related U.S. Application Data
(63) Continuation of application No. PCT/JP2023/009692, filed on Mar. 13, 2023.

(30) Foreign Application Priority Data
Apr. 15, 2022 (JP) 2022-067837

(51) Int. Cl. H01C 7/02; H01C 1/14

(52) U.S. Cl. CPC H01C 7/027; H01C 1/1406

(57) ABSTRACT

A chip-type electronic component that includes: a ceramic body 20 having a volume V of 0.12 mm³ or less, wherein the ceramic body comprises: a perovskite compound containing Ti and Ba, and at least Si, and wherein an Si content in the ceramic body 20 satisfies: 0 mol %<[Si]≤0.62 mol %, where [Si] is the Si content (mol %) per 100 mol % of a total content of elements in the ceramic body excluding oxygen.

### CROSS REFERENCE TO RELATED APPLICATIONS

The present application is a continuation of International application No. PCT/JP2023/009692, filed Mar. 13, 2023, which claims priority to Japanese Patent Application No. 2022-067837, filed Apr. 15, 2022, the entire contents of each of which are incorporated herein by reference.

### TECHNICAL FIELD

The present disclosure relates to a chip-type electronic component, and more particularly to a chip-type electronic component comprising a semiconductor ceramic.

### BACKGROUND ART

Some ceramics are known to exhibit a piezoresistive phenomenon in which their resistance changes when a stress is applied. For example, ceramics such as La_{1-X}Sr_{X}MnO₃ and BaTiO₃ have the property (piezoresistive effect) of changing their resistance according to the magnitude of strain and the magnitude of stress (see, for example, Patent Document 1). A perovskite manganese oxide La_{1-X}Sr_{X}MnO₃ exhibits a relatively high piezoresistive effect at room temperature when X=0.25, and the resistivity changes by 7% when a strain is imparted at 150 MPa. A ceramic like the semiconductor BaTiO₃ exhibits a giant piezoresistive effect.
Patent Document 1: Japanese Patent No. 4611127

### SUMMARY OF THE DISCLOSURE

Chip-type electronic components, each including a ceramic body, are becoming increasingly smaller these days. As chip-type electronic components become smaller, a phenomenon becomes marked in which the electrical characteristics (e.g., resistance) of a chip-type electronic component change when it is subjected to a reliability test (e.g., a weathering test or a cold/hot thermal shock test) which includes a step of heating the electronic component to 150° C. or more. In particular, in the case of chip-type electronic components using a semiconductor ceramic, e.g. a positive temperature coefficient (PTC) thermistor using a semiconductor BaTiO₃ ceramic, their resistance changes significantly before and after a reliability test. This may lead to reduced reliability of such a chip-type electronic component.

It is therefore an object of the present disclosure to provide a chip-type electronic component which, after undergoing a reliability test that involves heating, does not exhibit a significant change in its electrical characteristics and thus is highly reliable.

In one aspect, the present disclosure provides a chip-type electronic component comprising: a ceramic body having a volume V of 0.12 mm³ or less, wherein the ceramic body comprises: a perovskite compound containing Ti and Ba, and at least Si, and wherein an Si content in the ceramic body satisfies: 0 mol %<[Si]≤0.62 mol %, where [Si] is the Si content (mol %) per 100 mol % of a total content of elements in the ceramic body excluding oxygen.

According to the present disclosure, it is possible to provide a chip-type electronic component which, after undergoing a reliability test that involves heating, does not exhibit a significant change in its electrical characteristics and thus is highly reliable.

### BRIEF DESCRIPTION OF THE DRAWINGS

FIG. 1 is a schematic perspective view of a chip-type electronic component according to embodiment 1.

FIG. 2 is a schematic cross-sectional view of the chip-type electronic component according to embodiment 1.

FIG. 3 is a partially enlarged schematic cross-sectional view showing another embodiment of a chip-type electronic component according to embodiment 1.

FIG. 4(a) is a graph showing the rate of change in resistance versus the Si content in a ceramic body, and FIG. 4 (b) is a graph showing the rate of change in resistance versus the piezoresistive coefficient of the ceramic body.

FIG. 5 is a graph showing the piezoresistive coefficient of a ceramic body versus the resistivity of the ceramic body.

### DESCRIPTION OF THE PREFERRED EMBODIMENTS

There is a demand for small-sized chip-type electronic components using a semiconductor ceramic, such as a positive temperature coefficient (PTC) thermistor. A small-sized chip-type electronic component sometimes exhibits a significant change in its electrical characteristics after it undergoes a heat treatment at 150° C. or more e.g. in a reliability test.

To elucidate this phenomenon, the inventors examined the change in electrical characteristics before and after such a heat treatment for PTC thermistors formed of the same material, but having different sizes (1005-mm size and 0603-mm size). The rate of change from the resistance before the heat treatment (initial resistance) to the resistance after the heat treatment (referred to herein as “the rate of change in resistance”) was sufficiently low in the relatively large-sized PTC thermistor, whereas in the 0603-mm small-sized PTC thermistor, the rate of change in resistance was sometimes unacceptably high.

The inventors then made intensive studies to determine the cause of the high rate of change in resistance in a small-sized chip-type electronic component as observed when it is subjected to a heat treatment, and have now discovered for the first time that the Si content of a ceramic body affects the rate of change in the resistance of an electronic component.

It has not hitherto been known that the Si content of a ceramic body can affect the rate of change in the resistance of an electronic component. The present inventors, through their further studies to elucidate the mechanism, have found that the effect of the Si content of a ceramic body on the rate of change in the resistance of a chip-type electronic component is exerted only when the electronic component is a small-sized one.

Thus, the present inventors have found a new problem that only arises in small-sized chip-type electronic components, and accomplished the present disclosure to solve the problem.

Embodiments of the present disclosure will now be described with reference to the drawings.

### Embodiment 1

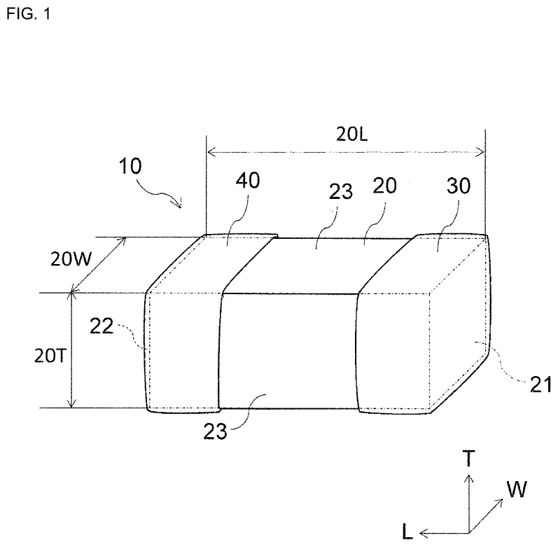

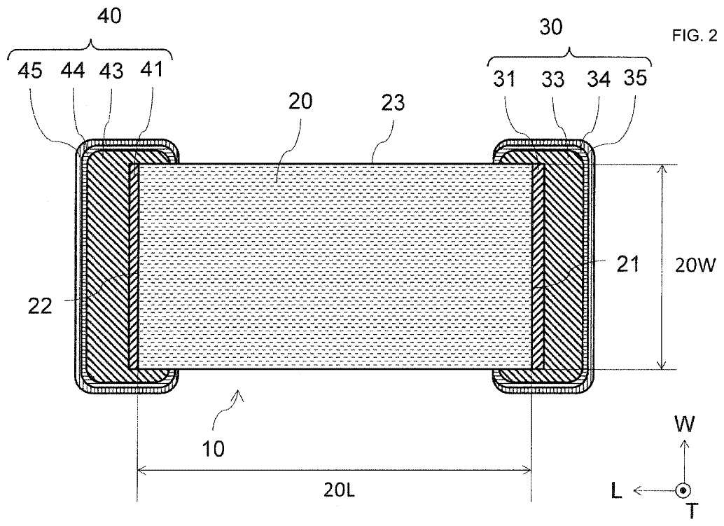

FIG. 1 is a schematic perspective view of a chip-type electronic component 10 (hereinafter sometimes referred to simply as “electronic component 10”) according to embodiment 1 of the present disclosure, and FIG. 2 is a schematic cross-sectional view of the electronic component 10.

The electronic component 10 includes at least a ceramic body 20. The electronic component 10 may further include outer electrodes 30, 40 on end portions of the ceramic body 20.

### (Ceramic Body 20)

In the small-sized electronic component 10 of the present disclosure, the ceramic body 20 used is also small-sized. The volume V of the ceramic body 20 is 0.12 mm³ or less.

In the present disclosure, by controlling the Si content in the ceramic body 20, the rate of change in resistance after heat treatment can be reduced despite the small-sized electronic component 10 including the small-sized ceramic body 20 having a volume V of 0.12 mm³ or less.

The volume V of the ceramic body 20 is preferably not less than 0.001 mm³ and not more than 0.12 mm³.

As shown in FIG. 1, when the ceramic body 20 has the shape of a rectangular prism with a length of 20L (mm), a width of 20W (mm), and a thickness of 20T (mm), the volume V (mm³) of the ceramic body 20 is calculated as V=20L×20W×20T.

The dimensions of the ceramic body 20 are preferably as follows: the length 20L is 0.6 mm or less, the width 20W is 0.3 mm or less, and the thickness 20T is 0.3 mm or less (i.e., 0603-mm size or smaller).

The ceramic body 20 comprises a perovskite compound containing Ti and Ba, and contains at least Si. The perovskite compound containing Ti and Ba is represented by the general formula BaTiO₃.

The material constituting the ceramic body 20 is a so-called semiconductor ceramic material, and may be sometimes referred to herein as a “semiconductor BaTiO₃ ceramic”.

In the electronic component 10 of the present disclosure, when the total content of elements (excluding oxygen) in the ceramic body 20 is taken as 100 mol %, the Si content in the ceramic body 20 is more than 0 mol % and not more than 0.62 mol %. In other words, the Si content in the ceramic body 20 satisfies the following inequality (1):

$$0 mol \% < [ Si ] \leq 0.62 mol \% \qquad ( 1 )$$

where [Si] is the Si content (mol %) per 100 mol % of the total content of elements (excluding oxygen) in the ceramic body.

The Si content in the ceramic body 20 is preferably not less than 0.10 mol % and not more than 0.50 mol %. In other words, the Si content in the ceramic body 20 preferably satisfies the following inequality (2):

$$0.1 mol \% < [ Si ] \leq 0.5 mol \% \qquad ( 2 )$$

By controlling the Si content in the ceramic body 20 within the above ranges, the rate of change in resistance before and after a reliability test can be reduced to a low level. Though the reason for this is not fully understood, the following is conceivable. It is to be noted that the present disclosure is not limited to the presumption described below.

When the ceramic body 20 of the electronic component 10 is subjected to stress, its resistance changes due to the piezoresistive effect. When the electronic component 10 is reflow-mounted on a mounting substrate by soldering, and then subjected to a reliability test (a weathering test or a cold/hot thermal shock test), a change of state (embrittlement, deterioration, deformation, expansion, contraction, etc.) occurs in the mounting substrate and the solder due to heating upon reflow mounting and to heating and cooling during the reliability test. When such a change of state occurs, a compressive or tensile stress acts on the ceramic body 20 of the electronic component 10.

The stress that acts on the ceramic body 20 is considered to change at various stages as follows. After the reflow mounting and before the reliability test, a tensile stress acts on the ceramic body 20. During the reliability the tensile stress is relaxed and a compressive stress acts on the ceramic body 20, and therefore the stress in the tensile direction is lower after the reliability test than before the reliability test. In other words, the stress in the compression direction is increased by the reliability test.

The expression “the stress in the compression direction is increased” includes (a) a case where a compressive stress acts on the ceramic body 20 after the reliability test, and the compressive stress is higher than that before the reliability test, and (b) a case where a tensile stress acts on the ceramic body 20 after the reliability test, and the tensile stress is lower than that before the reliability test.

In order to reduce the change (the rate of change in resistance) from the initial resistance of the electronic component 10 before the reliability test (when a tensile stress acts) to the resistance of the electronic component 10 after the reliability test (when stress in the compression direction increases), it is necessary to reduce the change in the resistance of the ceramic body 20 upon the increase in the stress in the compression direction. Here, piezoresistive coefficient π_{c} is introduced as an index of the change in the resistance upon the increase in the stress in the compression direction.

The piezoresistive coefficient π_{c} is the rate of change in the resistance of an electronic component per unit stress (compressive stress), and herein refers to the piezoresistive coefficient in a compression direction. The “piezoresistive coefficient in a compression direction” refers to a piezoresistive coefficient π_{c} calculated from a resistance value as measured when a current is passed through an electronic component in a direction parallel to the direction in which a compressive stress acts. The piezoresistive coefficient π_{c} (Ω %/MPa) in the compression direction of the ceramic body 20 can be represented by the following equation (3):

$${π}_{c} = Δ R / σ \times 100 \qquad ( 3 )$$

where ΔR (Ω) represents the amount of change in the resistance R of the ceramic body 20 in the compression direction, caused by the application of a compressive stress G (MPa).

Equation (3) can be rephrased as follows: When the compressive stress σ is represented on an x-axis, and the resistance R is represented on a y-axis, the compressive stress and the resistance in the compression direction are related by a linear function, and the slope of the graph corresponds to the piezoresistive coefficient π_{c} in the compression direction.

When determining the piezoresistive coefficient π_{c} based on actual measurement data, three or more resistance R values are measured for different compressive stresses σ. The data is plotted with the x-axis representing the compressive stress and the y-axis representing the resistance, and a regression line is drawn. The slope of the regression line (converted to a percentage) is the piezoresistive coefficient π_{c}. A resistance R value, which is measured under conditions in which the compressive stress σ is low (e.g., less than 7 MPa), is used as a reference resistance for the conversion to a percentage.

The present inventors have made intensive studies on the correlation between the piezoresistive coefficient π_{c} of the ceramic body 20 and its chemical composition, and have now found that the piezoresistive coefficient π_{c} of the ceramic body 20 is affected by the Si content in the ceramic body 20.

Though the reason why the Si content affects the piezoresistive coefficient π_{c} is not fully understood, the following mechanism is conceivable.

In the interior of the ceramic body 20, many ceramic grains lie adjacent to one another. The piezoresistive coefficient π_{c} of the ceramic body 20 is affected by the resistance at the grain boundaries of the ceramic grains (grain boundary resistance). The higher the grain boundary resistance, the higher the piezoresistive coefficient π_{c}.

The grain boundary resistance is high when an insulating layer is present at the grain boundaries. The thicker the insulating layer at the grain boundaries, the higher the grain boundary resistance.

Si in the ceramic body 20 is considered to be present in the form of SiO₂ or a complex oxide with a perovskite compound containing Ti and Ba (e.g., BaTiSi_{z}O_{3+2z}=BaO—TiO₂−zSiO₂) at the grain boundaries of the ceramic grains. When the Si content in the ceramic body 20 is high, an SiO₂ layer at the grain boundaries is thick, and therefore the grain boundary resistance is high and the piezoresistive coefficient π_{c} of the ceramic body 20 is high.

It appears that for these reasons, the piezoresistive coefficient π_{c} of the ceramic body 20 increases with increase in the Si content in the ceramic body 20.

As described above, the rate of change in the resistance of the electronic component 10 before and after a reliability test can be reduced by reducing the piezoresistive coefficient π_{c} of the ceramic body 20. It is therefore conceivable that in order to minimize the rate of change in the resistance of the electronic component 10, Si is desirably completely eliminated from the ceramic body 20.

However, SiO₂ is useful as a sintering aid upon sintering of the ceramic body 20. Further, Si can be contained in trace amounts in other raw material(s). In addition, trace amounts of Si can be mixed in as a contaminant from materials and equipment. Therefore, it is difficult to completely eliminate Si from the ceramic body 20.

The present inventors have found that in order to control the rate of change in resistance before and after a reliability test within an acceptable range (10% or less) while allowing the ceramic body 20 to contain Si, it is effective to make the Si content more than 0 mol % and not more than 0.62 mol %.

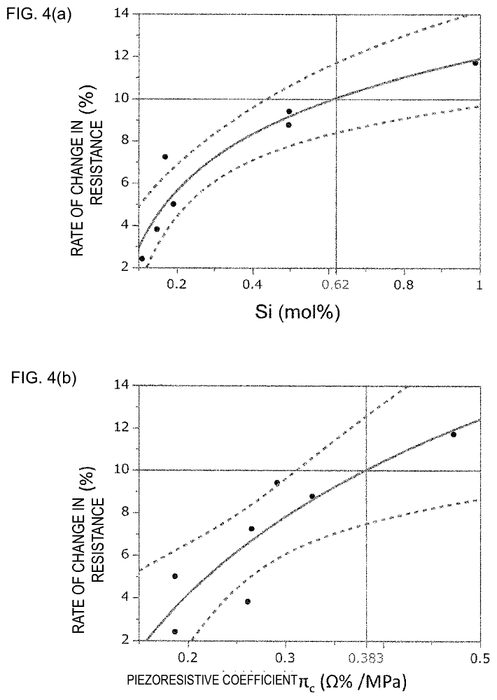

FIGS. 4(a) and 4(b) are graphs each showing the relationship of the rate of change in the resistance of the electronic component 10 before and after a reliability test with the Si content in the ceramic body 20 or with the piezoresistive coefficient π_{c} of the ceramic body 20.

The 7 data points in each graph were obtained using measurement samples manufactured in Examples 1 to 6 and Comparative Example 1.

FIG. 4(a) is a graph showing the rate of change in resistance versus the Si content of the ceramic body 20. The solid line in FIG. 4(a) is a regression line obtained through fitting using a least-square method. The regression equation is the following equation (4), and the coefficient of determination (R² value) is 0.90.

$$Rate of change in resistance ( \% ) = 11.886 + 3.9103 \times Ln [ Si ] \qquad ( 4 )$$

where [Si] represents the Si content (mol %) per 100 mol % of the total content of elements (excluding oxygen) in the ceramic body 20.

The dotted lines in FIG. 4(a) indicate the range of the 95% confidence interval (equivalent to 2σ) of the regression line (solid line).

As can be seen in the graph of FIG. 4(a), the rate of change in resistance before and after a reliability test can be reduced to 10% or less by making the Si content 0.62 mol % or less.

FIG. 4(b) is a graph showing the rate of change in resistance versus the piezoresistive coefficient π_{c} of the ceramic body 20. The solid line in FIG. 4(b) is a regression line obtained through fitting using a least-square method. The regression equation is the following equation (5), and the coefficient of determination (R² value) is 0.78.

$$Rate of change in resistance ( \% ) = 18.685 + 9.0541 \times Ln ( {π}_{c} ) \qquad ( 5 )$$

where π_{c} is a piezoresistive coefficient π_{c} (Ω %/MPa), and is determined by the above-described equation (3).

The dotted lines in FIG. 4(a) indicate the range of the 95% confidence interval (equivalent to 2σ) of the regression line (solid line).

As can be seen in the graph of FIG. 4(b), the rate of change in resistance before and after a reliability test can be reduced to 10% or less by making the piezoresistive coefficient π_{c} of the ceramic body 20 not more than 0.382 Ω %/MPa.

Thus, FIG. 4(b) indicates that when the ceramic body 20 is compressed, its piezoresistive coefficient π_{c} is preferably 0.382 Ω %/MPa or less.

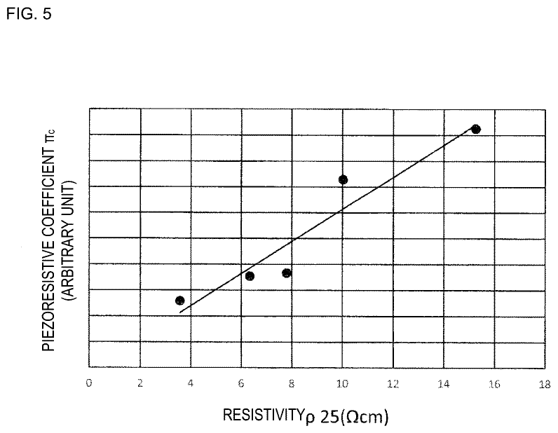

The piezoresistive coefficient π_{c} of the ceramic body 20 can also be affected by the resistivity of the ceramic body 20. This is because the higher the resistivity, the higher the grain boundary resistance in the ceramic body 20. The relationship between the piezoresistive coefficient π_{c} and resistivity of the ceramic body 20 can be seen in FIG. 5.

FIG. 5 is a graph showing the relationship between resistivity p and piezoresistive coefficient π_{c} in a ceramic body 20 produced from a semiconductor ceramic material having an Si concentration of 0.11 to 0.15 mol. As can be seen in FIG. 5, the resistivity p and the piezoresistive coefficient π_{c} are related by a linear function.

The present inventors, through their intensive studies, have found that electronic components including a ceramic body 20 having a resistivity ρ25 of 2.9 Ωcm or more at 25° C., when subjected to a heat treatment at 150° C. or more e.g. in a reliability test, exhibit a high rate of change in the resistance. However, a change in the electrical characteristics can be reduced by controlling the Si content of the ceramic body 20 as in the present disclosure. Thus, the present disclosure is particularly suitable for electronic components including a ceramic body 20 having a resistivity ρ25 of 2.9 Ωcm or more at 25° C.

The resistivity ρ25 of the ceramic body 20 can be controlled by the following method.

The perovskite structure (BaTiO₃) containing Ba and Ti, contained in the ceramic body 20, is an insulator when it has a composition conforming to the theoretical formula, and has a high resistivity ρ25. However, the resistivity ρ25 can be reduced by introducing oxygen defects into grain boundaries and grains in the interior of the ceramic body 20. The amount of oxygen defects at grain boundaries can be adjusted by the firing atmosphere, firing temperature, and firing time during firing of the ceramic body 20.

The resistivity can also be reduced by adding element(s) other than Ba and Ti to the raw material for the ceramic body 20.

In addition to the essential elements Ba, Ti, and Si, the ceramic body 20 may further contain the following optional elements.

The ceramic body 20 preferably contains in the perovskite compound at least one element selected from the group consisting of Ca, Sr, and Pb.

The ceramic body 20 may contain a rare earth element. The rare earth element preferably is at least one selected from the group consisting of Y, La, Ce, Pr, Nd, Sm, Eu, Gd, Tb, Dy, Ho, Er, Tm, Yb, and Lu. An oxide of such a rare earth element can be added as a semiconducting agent during the production of the ceramic body 20.

The ceramic body 20 also preferably contains Mn. An oxide of Mn (Mn₂O₃) may be added as a property improver during the production of the ceramic body 20.

### (Outer Electrodes 30, 40)

The outer electrodes 30, 40 are provided on at least one, preferably both, of end portions of the ceramic body 20.

The outer electrodes 30, 40 may each include a first electrode layer 31, 41 which covers an end surface 21, 22 of the ceramic body 20, and a second electrode layer 33, 43 which covers the first electrode layer 31, 41. The outer electrodes 30, 40 may each further include a plating layer(s) that covers the second electrode layer 33, 43.

The first electrode layers 31, 41 are formed of a metal material which can make an ohmic connection to the semiconductor BaTiO₃ ceramic and can withstand a reliability test. The first electrode layers 31, 41 can be formed of, for example, at least one of a Cr film, an NiCr alloy film, an Al film, and an ohmic Ag electrode (containing Ag and Zn).

The second electrode layers 33, 43 are formed of a material which is conductive with the first electrode layers, protects the first electrode layers, and is capable of forming a plating layer on its surface. The second electrode layers 33, 43 can be formed of, for example, at least one of a conductive resin layer and a baked electrode layer. The conductive resin layer is formed of a conductive resin material comprising a resin and a conductive powder. The baked electrode layer is formed by baking of a metal paste material comprising a metal and an organic component.

The plating layer may consist of a single plating layer, or may have a multi-layer structure consisting of a plurality of plating layers.

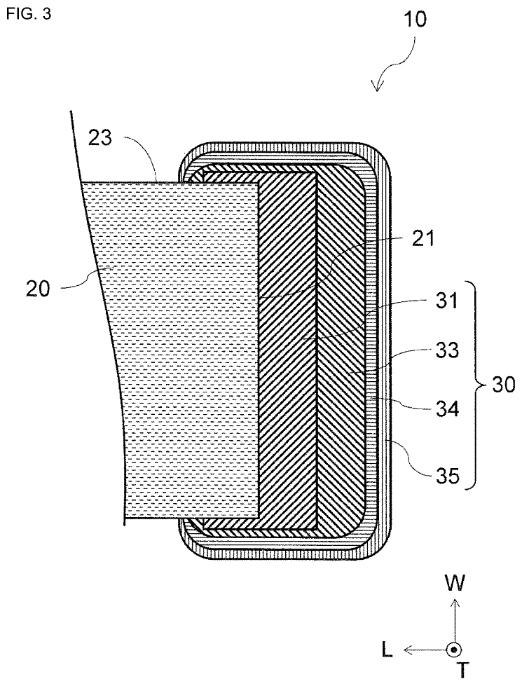

An example of the plating layer having a multi-layer structure is a plating layer having a two-layer structure consisting of a first plating layer 34, 44 in contact with the second electrode layer 33, 43, and a second plating layer 35, 45 which covers the first plating layer 34, 44 (see FIGS. 2 and 3).

The electronic component 10 of the present disclosure may be a thermistor, and particularly preferably is a PTC thermistor.

[Method for Manufacturing Chip-Type Electronic Component 10]

A method for manufacturing the electronic component 10 according to embodiment 1 will now be described using as an example a PTC thermistor having the structure shown in FIG. 1.

### (Production of Ceramic Body 20)

A raw material for the ceramic body 20 must contain BaCO₃ and TiO₂ in order to form a perovskite compound containing Ti and Ba. The raw material can also contain SiO₂ as an Si source. The SiO₂ can function as a sintering aid.

In the production of the ceramic body 20, a predetermined amount of a ceramic material such as BaCO₃, TiO₂, PbO, SrCO₃, CaCO₃, etc., and a predetermined amount of a rare earth additive (semiconducting agent) are first weighed as raw materials for the ceramic body. The rare earth additive may be, for example, an oxide(s) of at least one rare earth element selected from Y, La, Ce, Pr, Nd, Sm, Eu, Gd, Tb, Dy, Ho, Er, Tm, Yb, and Lu. In addition to the ceramic material and the rare earth additive, a property improver such as Mn₂O₃ and a sintering aid such as SiO₂ may also be used as raw materials for the ceramic body. The respective weighed materials are placed into a ball mill together with a milling medium such as partially stabilized zirconia (PSZ) (hereinafter also referred to as PSZ balls) and pure water, and wet-mixed and milled. The resulting mixture is calcined at a predetermined temperature (e.g., 1000 to 1200° C.) to obtain a calcined powder.

An organic binder, a dispersant, and pure water are added to and mixed with the calcined powder, and the mixture is dried to form granules. The granules are molded to obtain a molded product. The molded product is degreased and debindered, and then fired at a predetermined temperature (1200 to 1400° C.) in a predetermined atmosphere for a predetermined time to obtain a ceramic body 20.

### (Formation of First Electrode Layers 31, 41)

As shown in FIGS. 2 and 3, first electrode layers 31, 41 are formed such that they cover end portions of the ceramic body 20 (only the end surfaces 21, 22 of the ceramic body 20 as shown in FIG. 2, or the end surfaces 21, 22 and part of the side surfaces 23 of the ceramic body 20 as shown in FIG. 3).

The material of the first electrode layers 31, 41 is not particularly limited as long as it can make an ohmic connection to the ceramic body 20 and can withstand a reliability test. The first electrode layers 31, 41 may be formed of a metal material that can make ohmic contact with the ceramic body 20, for example, a metal material such as Zn, Ni, Al, Cr, V, or W, an alloy of such a metal with Ag, or an alloy material such as NiCr. In particular, a solid metal material such as Cr, a NiCr alloy, Al, or Zn—Ag (ohmic Ag) is preferred.

The first electrode layers 31, 41 can be formed by a known film forming method. For example, a sputtering method, a vapor deposition method, a coating method (involving applying a conductive paste to a predetermined position, and then baking the paste), or a dipping method can be used.

For example, a sputtering method is suitable for a Cr film, a NiCr alloy film, or an Al film, while a method involving coating and subsequent baking is suitable for a Zn—Ag film (ohmic Ag film).

### (Formation of Second Electrode Layers 33, 43)

As shown in FIGS. 2 and 3, second electrode layers 33, 43 are formed such that they cover the first electrode layers 31, 41.

The material of the second electrode layers 33, 43 is not particularly limited as long as it is conductive with the first electrode layers, protects the first electrode layers, and is capable of forming a plating layer on its surface. The second electrode layers 33, 43 can each be, for example, at least one of a conductive resin layer and a baked electrode layer. The conductive resin layer and the baked electrode layer will be described in detail below.

### Conductive Resin Layer

The conductive resin layer is formed by curing a fluidic resin electrode paste. The resin electrode paste contains a conductive powder and a resin material. The resin electrode paste is applied to end portions of the ceramic body 20 such that it covers the first electrode layers 31, 41, and then the resin material in the resin electrode paste is cured.

A metal powder such as Ag, Au, Ni, Cu, Pt, Pd, or Al can be used as the conductive powder contained in the resin electrode paste.

A resin material such as an epoxy resin, a phenolic resin, a urethane resin, a silicone resin, or a polyimide resin can be used as the resin material contained in the resin electrode paste.

### Baked Electrode Layer

The baked electrode layer is formed by baking a fluidic metal paste. The metal paste contains a metal powder, an organic binder, and an organic solvent. The metal paste is applied to end portions of the ceramic body 20 such that it covers the first electrode layers 31, 41, and the metal paste is dried, and then baked at 300 to 900° C.

A metal powder such as Ag, Au, Ni, Cu, Pt, or Pd can be used as the metal powder contained in the metal paste.

A cellulose resin such as an ethyl cellulose resin or a nitrocellulose resin, or an acrylic resin such as a butyl methacrylate resin or a methyl methacrylate resin can be used as the organic binder.

A terpene solvent such as terpineol or dihydroterpineol, a hydrocarbon solvent such as cyclohexane or trimethylbenzene, or a ketone solvent such as methyl ethyl ketone can be used as the organic solvent.

### (Formation of First Plating Layers 34, 44 and Second Plating Layers 35, 45)

A plating layer is formed such that it covers the surfaces of the second electrode layers 33, 43. The plating layer preferably has a multi-layer structure including a first plating layer 34, 44 in contact with the second electrode layer 33, 43, and a second plating layer 35, 45 which covers the first plating layer 34, 44. In this case, the first plating layer 34, 44 is formed such that it covers the surface of the second electrode layer 33, 43, and then the second plating layer 35, 45 is formed such that it covers the first plating layer 34, 44.

The first plating layers 34, 44 can be formed, for example, by electrolytic plating of at least one of Ni and Cu. The second plating layers 35, 45 can be formed, for example, by electrolytic plating of Sn. The first plating layers 34, 44 and the second plating layers 35, 45 can be formed by a known plating method, for example barrel plating using balls.

While the method for manufacturing the electronic component 10 according to embodiment 1 of the present disclosure has been described using a PTC thermistor as an example, the above description basically applies to the manufacturing of other chip-type electronic components.

### EXAMPLES

The following examples illustrate the present disclosure in greater detail and are not intended to limit the scope of the disclosure.

In the examples, PTC thermistors were manufactured as measurement samples (electronic components 10). In the PTC thermistors of the examples, the ceramic body 20 contained a perovskite compound containing Ba, Ca, Sr, Pb, and Ti, and also contained Sm, Er, Mn, and Si.

The measurement samples were manufactured by the following procedure. Approximately 5,000 measurement samples can be manufactured in one manufacturing run.

### Examples 1 to 6, Comparative Example 1

A ceramic body 20, having the composition and the resistivity ρ25 shown in Table 1, was prepared. Outer electrodes 30, 40 were provided on both end portions of the ceramic body 20, thereby manufacturing a measurement sample (electronic component 10) for use in measurements.

The ceramic body 20 was prepared through milling and mixing of raw materials, calcination, molding, firing, and cutting. The milling and mixing of raw materials was performed by mixing, milling and drying BaCO₃, CaCO₃, SrCO₃, PbO, TiO₂, at least one of Sm₂O₃ and Er₂O₃ as a rare earth element, MnO₂ as a property improver, and SiO₂ as a sintering aid in such amounts as to make the composition shown in Table 1. The resulting dried powder was calcined at a maximum temperature of 1200° C. in an air atmosphere. The dash (-) in table 1 indicates that the component was not added (and therefore was not detected upon measurement). An organic binder, a dispersant, and pure water were added to and mixed with the resulting calcined powder, and the mixture was dried to form granules. The resulting granules were subjected to compression molding. The molded product was degreased and debindered, and then fired at a maximum temperature of 1380° C. The fired product was cut into a predetermined size to obtain a ceramic body (measurement sample). The firing was performed in an air atmosphere. The resistivity ρ25 of the electronic component was adjusted by adjusting the firing time.

The ceramic bodies 20, used in Examples 1 to 6 and Comparative Example 1, had the shape of a rectangular prism and had the following dimensions (equivalent to a 0603-mm chip). In the examples, the dimensional values were used for each ceramic body 20.
Length 20L: 0.53 mm
Width 20W: 0.28 mm
Thickness 20T: 0.28 mm
Volume V: 0.042 mm³

Outer electrodes were formed on both ends of each ceramic body 20 as follows: First electrode layers 31, 41 were formed by sequentially forming a Cr film, a NiCu film, and an Ag film on top of each other by sputtering. Subsequently, resin electrode layers containing an Ag powder were formed as second electrode layers 33, 43 on the first electrode layers by a dipping method. No plating layer was formed.

In this manner, electronic components 10 for measurements (measurement samples) were manufactured.

In each of the examples, a number of measurement samples, required for each measurement, were randomly selected from approximately 5,000 measurement samples manufactured, and were subjected to the measurement.

### (Compositional Analysis of Ceramic Body 20)

The composition of each ceramic body 20 was analyzed using wavelength dispersive X-ray fluorescence analysis (WD-XRF) and inductively coupled plasma mass spectrometry (ICP-MS).

WD-XRF was used to measure the contents of high-concentration elements and Si. In particular, the contents of Ba, Ti, Sr, Pb, Ca, and Si were measured by WD-XRF.

ICP-MS was used to measure the contents of low-concentration elements. In particular, the contents of Er, Sm, and Mn were measured by ICP-MS. The content of Ba was also measured by ICP-MS to use it as a reference when integrating the ICP-MS results with the WD-XRF results.

A method for measuring the contents of elements using WD-XRF or ICP-MS will be described in detail below.

### WD-XRF:

A measurement sample was cut, and the internal composition of the ceramic body 20 was analyzed. In this manner, an accurate elemental concentration analysis can be performed without being affected by foreign matter, a coating, etc. attached to the outer surface of the measurement sample.

In the present disclosure, an electronic component of 0603-mm size was embedded in a two-component curing resin, and polished with abrasive paper of 500 to 4000 grit until the interior of the electronic component became exposed. The polished surface was then ultrasonically cleaned with ion-exchanged water, and then subjected to ion milling using IM4000 Plus manufactured by Hitachi High-Tech Corporation.

A WD-XRF apparatus Rigaku ZSX Series, with a tube Rh target, a vacuum atmosphere (13 Pa), and an attachment having a measurement diameter of 0.1 mm, was used. Three measurements were performed on different samples in each of the examples. The tube voltage, the tube current, and the measurement time were set appropriately, depending on an element to be measured, in the ranges of: the tube voltage 30 to 50 kV, the tube current 60 to 133 mA, and the measurement time 60 to 480 seconds/element. In each measurement, data on the spectral intensity of a target element was obtained. The operation of changing a measurement sample, performing a measurement, and obtaining data was repeated to obtain three measurement data. The average value (average intensity) of the measurement data was calculated for each target element, and the average intensity was converted into the content of the target element using a calibration curve stored in the apparatus.

In the examples, one measurement sample was used for one measurement.

If the spectral intensity of a measurement sample is weak because of the small size of the sample, a plurality of measurement samples may be used. For example, the spectral intensity can be increased by placing a line of measurement samples on a measurement stage to increase the measurement area and, in addition, increasing the spot diameter during measurement. Even with the same number of measurement samples, the spectral intensity can be increased by increasing the measurement time.

### ICP-MS

A measurement sample was completely dissolved in a mixed acid, and diluted to a predetermined concentration depending on an element to be measured, and was analyzed.

When the sample is not composed solely of a ceramic and contains other material(s) such as a plating, an electrode, a coating, etc. and when the material(s) comprises the same component(s) as a component(s) of the composition of the ceramic in a concentration which will adversely affect the results of analysis, it is preferred to remove the material(s) prior to the complete dissolution of the sample. Examples of methods for the removal of a target material include a method which involves selectively dissolving the material and a method which involves mechanically polishing away the material.

2.5 mg of a measurement sample was placed in 10 g of a mixed acid, and completely dissolved in the mixed acid in a microwave pressurized dissolution apparatus to prepare a solution (stock solution) for measurement. The same operation was performed twice to prepare two stock solutions. Each stock solution was diluted to a predetermined concentration, and used as a measurement solution. ICP-MS measurement was performed on the measurement solutions prepared from the stock solutions, and the average of the measurement values (contents of elements) was determined.

The mixed acid was prepared by mixing ultra-high purity grade hydrofluoric acid (46-51%), ultra-high purity grade nitric acid (46-51%) and ultrapure water, all manufactured by Kanto Chemical Co., Inc., at a weight ratio of 1:34:65.

iCAP 6300, manufactured by Thermo Fisher Scientific, was used as an ICP-AES apparatus. Agilent 7500cx, manufactured by Agilent Technologies, was used as an ICP-MS apparatus.

The results of the WD-XRF measurement were integrated with the results of the ICP-MS measurement by the following procedure.

The ratio of each of the contents of Er, Sm, and Mn, measured by ICP-MS, to the content of Ba, measured by ICP-MS, was calculated. The ratios thus calculated were multiplied by the content of Ba measured by WD-XRF, thereby converting the contents of Er, Sm, and Mn into those as measured by WD-XRF. Thereafter, the total amount of all elements (WD-XRF measurement values, or WD-XRF conversion values) was then normalized to 100.0 mol % to determine the contents of the respective elements. Upon the normalization, the content of each element was rounded to three significant figures.

### (Measurement of Resistivity ρ25)

50 measurement samples were randomly selected from approximately 5,000 measurement samples manufactured, and the resistances of the measurement samples (resistance R25 at 25° C.) were measured. The resistivity of each measurement sample was calculated from the measured resistance value and the dimensions of the measurement sample. The resistance of the outer electrodes and the resistance at the interface between the electrodes and the ceramic body were negligibly low; therefore, the resistivity of each measurement sample (electronic component) was regarded as the resistivity of the ceramic body 20.

Any commercially available digital multimeter can be used as a resistance meter for measuring the resistance R25. Any digital multimeters will produce approximately the same measurement results. The resistance is measured with a digital multimeter in contact with the outer electrodes of a measurement sample.

In the examples, the resistance R25 was measured using, as a resistance meter, a digital multimeter R6451A manufactured by Advantest Corporation.

The resistance R25 (Ω) was measured for each measurement sample, and the resistivity ρ25 (Ωcm) was determined by the following equation (6). The ceramic body 20 (measurement sample) has a generally rectangular parallelepiped shape with the dimensions of width 20W (mm), length 20L (mm), and thickness 20T (mm).

$$Resistivity ( ρ 25 ) = resistance ( R 25 ) \times width ( 20 W ) \times thickness ( 20 T ) / length ( 20 L ) \times 10 \qquad ( 6 )$$

The resistivity of each of the 50 measurement samples was determined, and the average value was calculated and shown in the “—ρ25” column in Table 1.

### (Reliability Test)

A reliability test was conducted by the following procedure for each of the 50 measurement samples which were selected for the measurement of resistivity ρ25. The reliability test (cold/hot thermal shock test) was conducted according to the AEC-Q200 standard.

First, a measurement samples was reflow-mounted on a mounting substrate made of glass/epoxy resin (Panasonic FR-4, thickness 1.6 mm) using a solder paste (M705-GRN360-K2K-J, Senju Metal Industry Co., Ltd.) at a reflow temperature of 250° C.

Next, the measurement sample, which had been mounted on the substrate, was subjected to a cold/hot thermal shock test under the conditions of: low temperature −55° C., high temperature 150° C., 1000 cycles.

### (Calculation of Piezoresistive Coefficient π_{c})

Measurement of a resistance for calculation of the piezoresistive coefficient π_{c} is performed using an apparatus which can measure the room-temperature resistance (resistance R25 at 25° C.) of an electronic component under the action of compressive stress.

The apparatus includes a compression jig for applying a compressive stress to an electronic component 10, and a resistance meter for measuring the resistance of the electronic component to which a compressive stress is being applied.

The compression jig clamps the electronic component 10 and applies a compressive stress to it. The area of a surface of the jig, which is to contact a surface of the electronic component 10, may be larger than the area of the surface of the electronic component 10. This enables a uniform compressive stress to be applied to the entire surface of the electronic component 10.

The compression jig includes a stress generating means for imparting a compressive stress. A push-pull gauge or a spring, for example, can be used as the stress generating means.

A commercially available digital multimeter can be used as the resistance meter.

The range of the compressive stress applied during the measurement is not particularly limited; however, the upper limit should be less than a compressive stress at which the ceramic body 20 no more deforms elastically, i.e., should be a compressive stress just before the yield point.

When measurement data is plotted with an x-axis representing the compressive stress and a y-axis representing the resistance, the resistance increases in proportion to the compressive stress. When the compressive stress exceeds the yield point of the ceramic body 20, the ceramic body 20 may begin to break down, so that the proportional relationship between the compressive stress and the resistance may no longer hold.

It is most preferred to perform the measurement within a stress range where the proportional relationship holds between the compressive stress and the resistance.

A compression jig using a spring, and a digital multimeter were used in the examples.

The compression jig has a pair of opposing compression arms for holding a measurement sample (electronic component) therebetween. The pair of compression arms was brought into contact with the pair of outer electrodes provided on the end surfaces of a measurement sample, and then the spacing between the compression arms was narrowed to apply a compressive stress to the measurement sample in a direction perpendicular to the end surfaces.

The compression jig includes a conductive portion. The outer electrodes of the measurement sample, which were in contact with the compression jig, were electrically connected to the digital multimeter via the conductive portion. The direction in which a compressive load was applied to the measurement sample was made parallel to the direction in which electricity was passed through the measurement sample. While applying the compressive load to the measurement sample, the resistance R25 of the measurement sample at room temperature (25° C.) was measured.

The compressive load was changed using Hooke's law (F=kx, F: load (N), k: spring constant (N/mm), x: the length of compression/extension of spring (mm)). Thus, the compressive load F applied to the measurement sample was changed by using springs with various spring constants k and by changing the length x of compression/extension of a spring.

The applied compressive load was 0.59 to 3.43 N. The compressive load was divided by the area of a WT cross-section of the ceramic body 20 of the measurement sample (0.28 mm×0.28 mm=0.0784 mm²) to convert it into a compressive stress of 7.5 to 43.8 MPa.

The measurement data was plotted with an x-axis representing the compressive stress and a y-axis representing the resistance, and a regression line was drawn based on the plot. The piezoresistive coefficient π_{c} was determined from the slope of the regression line (converted to a percentage). A resistance value, which was measured at a compressive stress of less than 7 MPa, was used as a reference resistance for the conversion to a percentage.

The piezoresistive coefficient π_{c} was determined for each of three measurement samples, and the average value was calculated and shown in the “piezoresistive coefficient π_{c}” column in Table 2.

### (Evaluation of the Rate of Change in Resistance)

10 measurement samples were heated in a reflow furnace and mounted on a substrate. A reliability test (cold/hot thermal shock test) was conducted on the measurement samples mounted on the substrate. The resistance (resistance R25 at 25° C.) of each measurement sample was measured before and after the cold/hot thermal shock test.

The resistance measurement was performed using the same digital multimeter as that described above under the heading “Measurement of Resistivity ρ25”; however, a different type of digital multimeter may also be used.

The digital multimeter was brought into contact with wiring of the substrate to measure the resistances of the measurement samples.

For each measurement sample, the resistance R25b before the reliability test (cold/hot thermal shock test) and the resistance R25a after the test were measured, and the rate of change in the resistance was determined by the following equation (7):

$$Rate of change in resistance ( \% ) = ( R 25 a / R 25 b - 1 ) \times 100 \qquad ( 7 )$$

The rate of change in the resistance was determined for each of the 10 measurement samples, and the average value was calculated and shown in the “Rate of Change in Resistance” column in Table 2.

TABLE 1

| | Composition (mol %) | | | | | | | | | ρ25 |
|---|---|---|---|---|---|---|---|---|---|---|
| | Ba | Ti | Sr | Pb | Ca | Si | Er | Sm | Mn | (Ωcm) |
| Ex. 1 | 27.3 | 47.3 | 11.3 | 7.54 | 6.37 | 0.110 | — | 0.0990 | 0.0224 | 7.3 |
| Ex. 2 | 27.5 | 48.2 | 10.3 | 7.10 | 6.62 | 0.149 | — | 0.0994 | 0.0186 | 15.6 |
| Ex. 3 | 29.5 | 49.4 | 6.82 | 7.13 | 6.83 | 0.192 | — | 0.102 | 0.0217 | 10.5 |
| Ex. 4 | 28.1 | 51.5 | 6.84 | 6.81 | 6.50 | 0.170 | — | 0.0986 | 0.0200 | 13.1 |
| Ex. 5 | 34.0 | 50.2 | 5.88 | 2.77 | 6.46 | 0.498 | 0.198 | — | 0.0323 | 16.4 |
| Ex. 6 | 26.9 | 49.9 | 11.4 | 5.22 | 5.96 | 0.497 | — | 0.134 | 0.00622 | 12.6 |
| Comp. | 26.8 | 49.6 | 11.4 | 5.19 | 5.93 | 0.989 | — | 0.133 | 0.00618 | 12.8 |
| Ex. 1 | | | | | | | | | | |

TABLE 2

| | Piezoresistive coefficient π_{c} | Rate of change in |
|---|---|---|
| | (Ω %/MPa) | resistance (%) |
| Example 1 | 0.19 | 2.4 |
| Example 2 | 0.26 | 3.8 |
| Example 3 | 0.19 | 5.0 |
| Example 4 | 0.27 | 7.2 |
| Example 5 | 0.29 | 9.4 |
| Example 6 | 0.33 | 8.8 |
| Comp. Example 1 | 0.47 | 11.7 |

In Examples 1 to 6 in which the Si content was within the range of the present disclosure, the rate of change in resistance before and after the reliability test was not more than 10%.

In Comparative Example 1 in which the Si content was outside the range of the present disclosure, the rate of change in resistance before and after the reliability test was more than 10%.

The present disclosure includes the following embodiments:

### Embodiment 1

A chip-type electronic component comprising a ceramic body, wherein the volume V of the ceramic body is 0.12 mm or less, wherein the ceramic body comprises a perovskite compound containing Ti and Ba, and contains at least Si, and wherein the Si content in the ceramic body satisfies: 0 mol %<[Si]≤0.62 mol %, where [Si] is the Si content (mol %) per 100 mol % of the total content of elements in the ceramic body excluding oxygen.

### Embodiment 2

The chip-type electronic component according to embodiment 1, wherein the Si content satisfies: 0.10 mol %≤[Si]≤0.50 mol %.

### Embodiment 3

The chip-type electronic component according to embodiment 1 or 2, wherein, when the ceramic body is compressed, the piezoresistive coefficient of the ceramic body in the compression direction is 0.382 Ω %/MPa or less.

### Embodiment 4

The chip-type electronic component according to any one of embodiments 1 to 3, wherein the ceramic body further comprises at least one of (a) to (c): (a) at least one selected from Ca, Sr, and Pb in the perovskite compound; (b) at least one selected from Y, La, Ce, Pr, Nd, Sm, Eu, Gd, Tb, Dy, Ho, Er, Tm, Yb, and Lu; and (c) Mn.

### Embodiment 5

The chip-type electronic component according to any one of embodiments 1 to 4, wherein the chip-type electronic component is configured as a thermistor.

### REFERENCE SIGNS LIST

10 chip-type electronic component
20 ceramic body
21, 22 end surfaces of the ceramic body
23 side surfaces of the ceramic body
30, 40 outer electrodes
31, 41 first electrode layers
33, 43 second electrode layers
34, 44 first plating layers
35, 45 second plating layers

1. A chip-type electronic component comprising:
a ceramic body having a volume V of 0.12 mm³ or less, the ceramic body comprising:
a perovskite compound containing Ti and Ba, and at least Si, and wherein an Si content in the ceramic body satisfies:
0 mol %<[Si]≤0.62 mol %,
where [Si] is the Si content (mol %) per 100 mol % of a total content of elements in the ceramic body excluding oxygen.

2. The chip-type electronic component according to claim 1, wherein the Si content satisfies:
0.10 mol %≤[Si]≤0.50 mol %.

3. The chip-type electronic component according to claim 1, wherein the volume of the ceramic body is 0.001 mm³ to 0.12 mm³.

4. The chip-type electronic component according to claim 1, wherein the Si content is 0.11 to 0.15 mol %.

5. The chip-type electronic component according to claim 1, wherein when the ceramic body is compressed, a piezoresistive coefficient of the ceramic body in a compression direction is 0.382 Ω %/MPa or less.

6. The chip-type electronic component according to claim 1, wherein the ceramic body further comprises at least one of:
(a) at least one selected from Ca, Sr, and Pb in the perovskite compound;
(b) at least one selected from Y, La, Ce, Pr, Nd, Sm, Eu, Gd, Tb, Dy, Ho, Er, Tm, Yb, and Lu; and
(c) Mn.

7. The chip-type electronic component according to claim 1, wherein the ceramic body further comprises at least one selected from Ca, Sr, and Pb in the perovskite compound.

8. The chip-type electronic component according to claim 1, wherein the ceramic body further comprises at least one selected from Y, La, Ce, Pr, Nd, Sm, Eu, Gd, Tb, Dy, Ho, Er, Tm, Yb, and Lu.

9. The chip-type electronic component according to claim 1, wherein the ceramic body further comprises Mn.

10. The chip-type electronic component according to claim 1, wherein the ceramic body further comprises:
at least one selected from Ca, Sr, and Pb in the perovskite compound;
at least one selected from Y, La, Ce, Pr, Nd, Sm, Eu, Gd, Tb, Dy, Ho, Er, Tm, Yb, and Lu; and
Mn.

11. The chip-type electronic component according to claim 1, wherein the ceramic body has a resistivity ρ25 of 2.9 Ωcm or more at 25° C.

12. The chip-type electronic component according to claim 1, wherein the chip-type electronic component is configured as a thermistor.
